(19) United States
(12) Patent Application Publication
(10) Pub. No.: US 2014/0363031 A1
(43) Pub. Date: Dec. 11, 2014

(54) Analog Input Module

(71) Applicant: Siemens Aktiengesellschaft, Muenchen (DE)

(72) Inventor: Thomas Nötzold, Bernsdorf (DE)

(21) Appl. No.: 14/300,568

(22) Filed: Jun. 10, 2014

(30) Foreign Application Priority Data
Jun. 11, 2013 (EP) 13171344

(51) Int. Cl. H04R 3/00

(52) U.S. Cl. CPC H04R 3/00
USPC 381/123

(57) ABSTRACT

An analog input module includes an activation unit, an analog/digital converter, an input circuit with a first input and a second input and a voltage divider disposed between the first input and the second input. The activation unit is connected to the first input and the second input and is connected upstream of the analog/digital converter. The voltage divider has center tap which is connected to a first comparator input of a comparator of a closed-loop control unit. The closed-loop control unit has a switching device disposed between the second input and a reference point. The comparator includes a second comparator input which is connected to a reference source. The comparator has a control output which is connected to a control input of the switching device. The closed-loop control unit is configured such that the switching device enables or disables a current path to the reference point.

### FIELD OF INVENTION

The invention relates to an analog input module. Specifically, the invention relates to an input module comprising an activation unit, an analog/digital converter, an input circuit with a first input and a second input, and a voltage divider which is disposed between the first input and the second input, wherein the activation unit is connected to the first and second input and is connected upstream of the analog/digital converter.

### DESCRIPTION OF THE RELATED ART

Analog input modules are used in industrial automation technology, for example, to measure process variables. For instance, transducers can be connected to the analog input modules. One application of the analog input module with connected transducers is the conversion of the process variables into standardized current ranges. The transducers can be classified according to their connection type into a two-wire transducer or a four-wire transducer. A two-wire transducer is used directly via a supply voltage in a current loop to the analog input module. The process variable converted by the two-wire transducer in this case may be mapped in the supply current of the two-wire transducer. As the name two-wire transducer suggests, only two wires are needed for the connection. Because of the direct relationship of the two-wire transducer to the supply voltage, the measuring system, i.e., the analog input module, is related electrically to a reference point, such as a frame ground.

By contrast, a four-wire transducer is always fed with a separate supply voltage. The actual current loop for the converted process variable is connected separately from the supply voltage. Therefore, a total of four wires (two-times supply voltage and two-times current loop of the measurement signal) is needed for connection to an analog input module. Because of the separate current loop in the four-wire transducer, the measurement system, i.e., the analog input module, is mostly galvanically separated from the supply voltage, and not related electrically to a frame ground.

Two-wire transducers are increasingly being used, in which an output signal ranges from 4 to 20 mA. A four-wire transducer delivers an output signal ranging from 0 to 20 mA. A circuit arrangement for adapting a two-wire transducer to a four-wire measurement system is already known from DE 44 26 765 C1.

### SUMMARY OF THE INVENTION

An object of the invention is to provide an analog input module which, without additional circuit components/elements for conversion, makes it possible to connect to both a two-wire transducer and a four-wire transducer. A further object of the invention is to provide an alternative for the circuit arrangement set forth in DE 44 26 765 C1 such that the alternative manages with a smaller circuit outlay.

The object of the invention is achieved by an analog input module comprising an activation unit, an analog/digital converter, an input circuit with a first input and a second input, and a voltage divider, which is disposed between the first input and the second input,. The activation unit is connected to the first input and the second input and is connected upstream of the analog/digital converter, by the voltage divider having a center tap which is connected to a first comparator input of a comparator . The closed-loop control device has switching device(s) which are disposed between the second input and a reference point. The comparator includes a second comparator input which is connected to a reference source. The comparator has a control output which is connected to a control input of the switching devices. The closed-loop control unit is configured such that the switching device, on connection of a two-wire transducer to a first input and while the second input remains unswitched, enables a current path to the reference point, and on connection of a four-wire transducer to the first input and the second input, disables the current path to the reference point.

According to the prior art, previously either an expensive circuit arrangement (as per, e.g., DE 44 26 765 C1) or separate input circuits for two-wire and four-wire connections have been used in current measurement. If a common input circuit were to be used for both types of transducer, a suitable circuit element would have to be employed and controlled in the measuring module for switching between the two types of connection. Other analog input modules or measurement modules would have again required an external cable bridge on the measurement inputs. These disadvantages are now overcome by the analog input module of the present invention.

The prior art analog input module has been expanded by the invention. Specifically, a frame-ground-free, differentially structured measurement input of the input circuit for the connection of a four-wire transducer has been expanded by a closed-loop control unit such that the closed-loop control unit is also suitable for the connection of a two-wire transducer. In this case the voltage divider is held in a required operating point and, simultaneously, a current path is made possible to the reference point, which implements a return of the current to a supply frame without the necessity of an additional switching element in the analog input module.

In one embodiment, the voltage divider has a first resistor and a second resistor in a series circuit, wherein the center tap is disposed between the first and the second resistor. Preferably, the voltage divider with its first resistor and its second resistor is symmetrical in structure, which means that the resistance values are approximately the same. Thus, a symmetrically constructed input circuit is obtained for the connection of a four-wire transducer, which can also be used as required for the connection of a two-wire transducer.

In another embodiment, the comparator is an operational amplifier and the switching device is a semiconductor switching device, such as a transistor.

In summary, the analog input module of the present invention has an input circuit available to it which makes possible shared use of a two-wire transducer or of a four-wire transducer through the differentially constructed input circuit without an additional switching signal or a switching element having to be used for switching between the two modes of operation. A differentially-constructed measurement input is now available for the connection of a four-wire transducer which has been expanded by the closed-loop control unit such that the input is also suitable for the connection of a two-wire transducer.

### BRIEF DESCRIPTION OF THE DRAWINGS

An exemplary embodiment is described in greater detail in the drawings, in which:

FIG. 1 shows an analog input module with a connected two-wire transducer in accordance with one embodiment of the present invention; and

FIG. 2 shows the analog input module with a connected four-wire transducer in accordance with one embodiment of the present invention.

### DETAILED DESCRIPTION OF THE PRESENTLY PREFERRED EMBODIMENTS

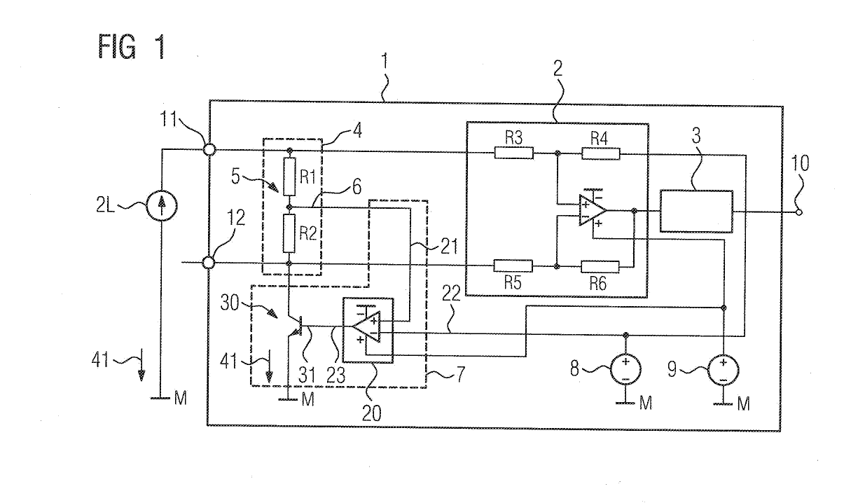

FIG. 1 illustrates an analog input module 1 comprising an activation unit 2, an analog/digital converter 3, an input circuit 4 with a first input 11 and a second input 12, and a voltage divider 5, which is disposed between the first input 11 and the second input 12. The activation unit 2 is connected to the first and second input 11, 12 and is upstream of the analog/digital converter 3. A voltage signal dropping via the voltage divider 5 is evaluated by the activation unit 2 and fed to the analog/digital converter 3, which then provides the converted digital signal for further processing via a digital output 10.

With the combination of the input circuit 4 and a closed-loop control unit 7, a combined input circuit 4 is now realized in the analog input module 1 without a conditional switchover for the two-wire transducer connection or the four-wire transducer connection for current measurement. To this end the voltage divider 5 has a center tap 6 which is connected to a first comparator input 21 of a comparator means 20 of the closed-loop control unit 7, wherein the closed-loop control unit 7 has a switching means 30 which is disposed between the second input 12 and a reference point M. The comparator means 20 includes a second comparator input 22 which is connected to a reference source 8, and the comparator means 20 has a control output 23 which is connected to a control input 31 of the switching means 30.

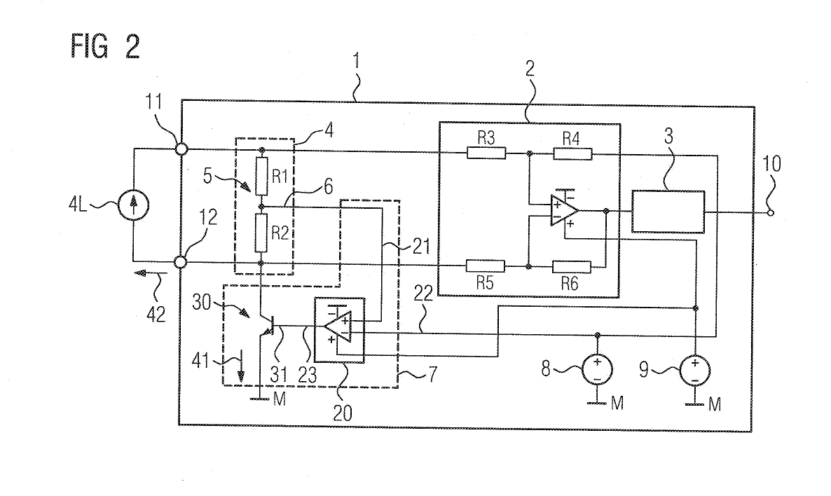

If, as is shown in FIG. 1, a two-wire transducer 2L is connected to the analog input module 1, this two-wire transducer 2L will be connected with its first conductor to the first input 11 and with its second conductor to a reference point M. The reference point M in this case symbolizes a common frame ground of the two-wire transducer 2L and the analog input module 1. The integration of the center tap 6 into the input circuit 4, wherein the center tap 6 of the closed-loop control unit 7 makes a closed-loop control variable available, means that it is now possible, without further circuit measures on the analog input module 1, to connect either a two-wire transducer 2L for measuring a process variable to the first input 11 or a four-wire transducer 4L (see FIG. 2) to the first input 11 and the second input 12.

In this case the closed-loop control unit 7 with its comparator means 20 and switching means 30 is configured such that the switching means 30, on connection of the two-wire transducer 2L to the first input 11 and while the second input 12 remains unconnected, enables a current path 41 to the reference point M. and on connection of a four-wire transducer 4L to the first input 11 and the second input 12, disables the current path 41 to the reference point M, but simultaneously to make possible a further second current path 42 back to the four-wire transducer 4L via the second input 12.

The comparator means 20 is constructed as an operational amplifier with a first comparator input 21 and a second comparator input 22 and a control output 23. The first comparator input 21 is connected to the center tap 6 and the second comparator input 22 is connected to the plus pole of a reference source 8. A positive voltage of, e.g., 2.5 V is provided via the reference source 8.

In one embodiment, the switching means 30 is an NPN transistor, wherein the emitter is connected to the reference point M and the collector has a connection to a node point to which the second input 12 and an end of the measurement bridge 6 are connected.

The activation unit 2 for the analog/digital converter 3 has a further operational amplifier with resistors R3, R4, R5 and R6 necessary for connection of the operational amplifier. A supply source 9 supplies the two operational amplifiers with a supply voltage.

FIG. 2 illustrates a four-wire transducer 4L is connected to the analog input module 1 at the first input 11 and at the second input 12. The four-wire transducer 4L is shown in the drawing in the form of a current source. For the connection type of the four-wire transducer 4L a second current path 42 between the first input 11, the first resistor RI and the second resistor R2 and the second input 12 is produced. An operating point with the potential of the reference voltage of the reference source 8 is produced as a condition of the activation circuit 2 between the first resistor RI and the second resistor R2. Since the impressed current has no reference to an electrical frame ground of the input circuit, the impressed current must exit from the input circuit via the second input 12, i.e., the switching means 20 will be activated via the operational amplifier of the comparator means 20 such that the switching means 30 blocks.

If the input circuit 4 is connected to a two-wire transducer 2L the second input 12 is not connected and a current loop or the current path 41 is closed via the reference point M, i.e., the electrical frame ground of the two-wire transducer 2L. To hold the input circuit 4 or the voltage divider 5 with its center tap 6 in its required operating point (reference voltage between the first resistor R1 and the second resistor R2), the comparator means 20 controls the switching means 30 via its control output 23 such that its output resistor generates the required voltage drop.

The introduced closed-loop control unit 7, having an operational amplifier and a transistor, possesses the following advantages:
1. The symmetrically-constructed input circuit 4 for the connection of a four-wire transducer can be used without restriction for the connection of a two-wire transducer.
2. No further additional circuit elements are necessary for switching between the two connection types.
3. Since no switching elements are necessary for the switchover, no additional activation signals are needed either.

Additional circuit elements, in particular for analog input modules with galvanic separation between control and measurement input, are not only demanding in terms of space but also very cost-intensive. In addition a firmware structure for an analog input module is simplified by the inventive combined input.

The series of detailed descriptions set forth above are only specific descriptions directed to the feasible embodiments of the present invention, and are not intended to limit the scope of protection of the present invention; and all the equivalent embodiments or modifications made without departing from the technical spirit of the present invention shall be included in the scope of protection of the present invention.

What is claimed is:

1. An analog input module comprising;
an activation unit;
an analog-to-digital (AD) converter;
an input circuit with a first input and a second input; and
a voltage divider disposed between the first input and the second input,
wherein the activation unit is connected to the first input and the second input and is connected upstream of the analog/digital converter,
wherein the voltage divider has center tap which is connected to a first comparator input of a comparator of a closed-loop control unit,
wherein the closed-loop control unit has a switching device disposed between the second input and a reference point,
wherein the comparator includes a second comparator input which is connected to a reference source,
wherein the comparator has a control output which is connected to a control input of the switching device,
wherein the closed-loop control unit is configured such that the switching device,
(1) on connection of a two-wire transducer to the first input and while the second input remains unconnected, enables a current path to the reference point; and
(2) on connection of a four-wire transducer to the first input and the second input, disables the current path to the reference point.

2. The analog input module of claim 1, wherein the voltage divider has a first resistor and a second resistor in a series circuit, and wherein the center tap is disposed between the first and the second resistor.

3. The analog input module of claim 1, wherein the comparator is an operational amplifier and the switching device is semiconductor switch.
